(19) United States
(12) Patent Application Publication
(10) Pub. No.: US 2021/0241555 A1
(43) Pub. Date: Aug. 5, 2021

(54) DOOR OPENER DISPLAY CONTROLLER, SYSTEMS AND METHODS

(71) Applicant: DOUGLASS TECHNOLOGIES, LLC, Chippewa Falls, WI (US)

(72) Inventors: CORBIN D. SEEBER, Chippewa Falls, WI (US); CHARLES M. BETZ, Eau Claire, WI (US); MICHAEL J. BUCHMANN, Chippewa Falls, WI (US); DAVID N. SPRINGER, Eau Claire, WI (US); DANIEL J. SEEBER, Hudson, WI (US)

(21) Appl. No.: 17/049,200

(22) PCT Filed: Apr. 25, 2019
(86) PCT No.: PCT/US19/29176

§ 371 Date: Oct. 20, 2020

Related U.S. Application Data
(60) Provisional application No. 62/662,923, filed on Apr. 26, 2018.

(51) Int. Cl. G07C 9/00; E05F 15/668; E06B 9/70

(52) U.S. Cl. CPC G07C 9/00896; E06B 9/70; E05F 15/668

(57) ABSTRACT

A display system and method of using a display system for use with an overhead door opener system having a motor and a transmission configured to open and automatically close an overhead door, the display system having a first digital multi-character display unit, and a controller having an adjustable door-closing delay counter, the controller configured to activate a numerical countdown and an alpha-character door-closing warning at the first display unit, the controller configured to display the door-closing warning at the first display unit while the overhead door is closing and after display of the numerical countdown at the first display unit. In aspects the system includes a camera for capture of video images while a door is opening, waiting to close and closing.

### CROSS-REFERENCE TO RELATED APPLICATIONS

The present application claims the benefit and priority of Provisional Patent Application Ser. No. 62/662,932 filed Apr. 26, 2018 for DIGITAL DISPLAY COMMUNICATION DOOR SYSTEM, CONTROLLER AND METHODS under 35 U.S.C. Section 119(e), which is hereby incorporated by reference as if fully reproduced herein.

### BACKGROUND OF THE INVENTION

Remote operated overhead door openers are in use in businesses, municipal buildings, parking areas and other locations where controlled access is essential or desired. A typical remote overhead door opener includes, in addition to the mechanical components of the door and the door mounting system, a motor capable of driving the door between an open and a closed position, and a motor-controller configured for connection to a power supply and configured to control the motor in response to signals to open and/or close the door. The typical system is configured to receive wireless signals so that an operator may cause the door to open or close, or by pushing a button, and without having to get out of a truck or vehicle to activate the opening or closing of the overhead door. Some commercial overhead door opener systems utilize an automatic timed door closing operation. There have been a variety of devices and systems used to safely and securely undertake remote operation of a door in various other applications, such as devices shown in U.S. Pat. Nos. 4,821,024, 5,357,183, 6,437,527 and US Patent Application No. 2003/0102836. While these and other devices or systems may have benefits, there is room for improvement.

### SUMMARY OF THE INVENTION

In one aspect the invention is a display system for use in conjunction with an existing overhead door and door opening system. The display system provides displayed messages to operators of vehicles approaching an overhead door so that the operator of the vehicle may ascertain a status of the door, including an actual time value as to when the open door will begin to close and including a multi-character, multi-color alpha and graphical display. In further aspects the invention includes an overhead door opener system incorporating the display system.

In a further aspect the invention includes a display system for use with an overhead door opener system having a motor and a transmission configured to open and automatically close an overhead door. The door opener system includes a timer, which automatically causes the door to close upon lapse of a pre-set time interval. The display system of the present invention includes a first multi-character display unit, and a display controller having an adjustable door-closing delay counter, the display controller configured to activate a numerical countdown and an alpha-character and/or graphical door-closing warning at the first display unit, the display controller configured to display the door-closing warning at the first display unit while the overhead door is closing and after display of the numerical countdown at the first display unit. In further aspects the system includes memory having instructions, which when executed, perform methods including receiving door status indicator from the door opener controller, sending a countdown signal to the display unit and sending, upon lapse of a pre-set time interval of a delay counter, a first door-closing signal to the door opener controller and a second door-closing signal to the display unit.

In a further aspect the invention pertains to a display controller configured to connect to a door opener system to provide display functionality for sending an alphanumeric and/or graphical signals to at least one display unit.

In further aspects of the invention includes multiple wireless devices integrated with the controller interface to provide additional operational status including video cameras, motion detectors and accelerometers. Capture of video images occurs when a trigger event has occurred such as the door is in motion from the time the door begins to open until the door is fully closed, the door has been struck by a vehicle or object, when a vehicle or object moves into the motion detection field.

In further aspects the invention includes methods of displaying a numerical countdown and a door-closing warning at a first display unit, the warning occurring while a commercial overhead door is closing or about to close and after display of the numerical countdown. In further aspects the invention includes retro-fitting conventional commercial door opener systems having legacy controllers utilizing a potentiometer as an automatic delay counter, and bypassing or disabling the legacy delay counter, receiving input data from the legacy controller, and outputting a door close signal to the legacy controller and outputting a door close signal to a display unit or units, including display of a numeric countdown and an alpha warning.

In further aspects the invention includes methods of recording events occurring at an overhead door opener system configured to automatically close based on a time lapse, the method including continually recording a video stream from a camera directed at an entrance or exit of the overhead door, and creating a video file of at least a portion of the recorded video stream upon receipt of an alarm signal sent in response to action of the door, the video file having a time-stamp corresponding to the alarm signal, the video file including video recorded prior to receipt of the alarm signal. In aspects, the time-stamp and recorded video clip is of a time prior to receipt of the alarm signal, the video file continuing to the end of the event. The video file is archived and may be sent to email or text or other communication accounts.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

FIG. 1 is a front view of a commercial overhead door and overhead door operator in accordance with one aspect of the present invention and showing the operator positioned within a building.

FIG. 2 is a side view illustration of the door and door operator shown in FIG. 1 together with a representative vehicle.

FIG. 3 is a schematic diagram of a controller and system aspect of the present invention as utilized in FIG. 1.

FIG. 4 is a block diagram showing representative features of a system aspect of the present invention.

FIGS. 5A, 5B, 5C and 5D are sequence block diagrams of representative logic of a display controller and display system of the invention.

FIG. 6 is a front view of a component for use with the opener and display systems in accordance with the invention showing a representative message/warning.

FIGS. 7A, 7B, and 7C are front views of display components for use with the opener and display systems in accordance with the invention showing representative messages/warnings.

FIGS. 8A, 8B, 8C, 8D and 8E are front views of display components for use with the opener and display systems in accordance with the invention showing representative messages/warnings.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

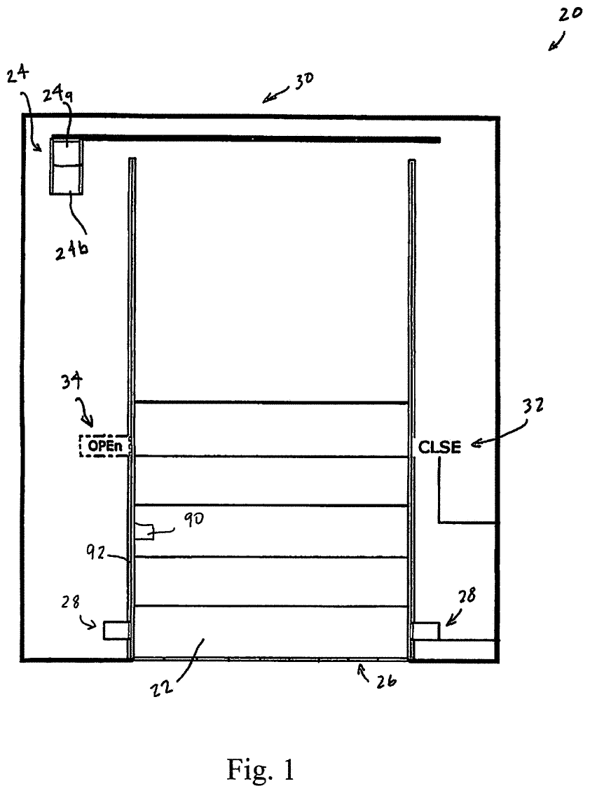

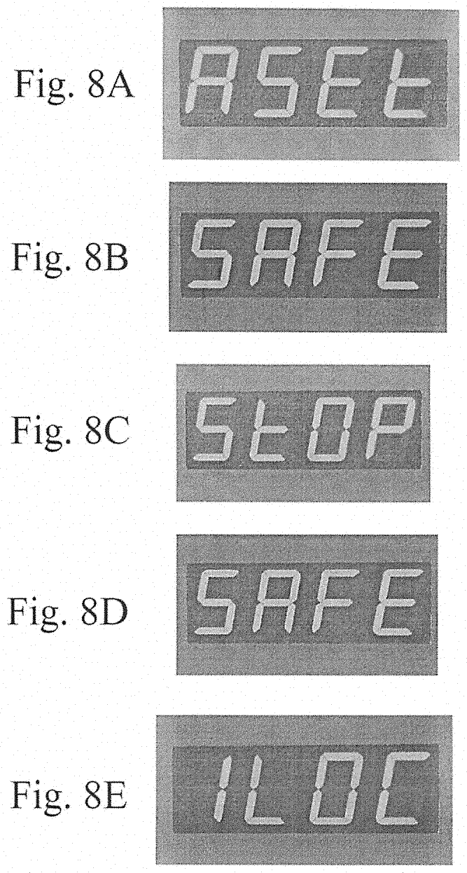

Referring to FIGS. 1-8, aspects of an overhead door opener system 20, display system 30 for use with a door opener system 20, a display controller 40, software and/or firmware 50, and related methods 100 for monitoring and controlling overhead doors are shown. The system 20 and/or display system 30 of the invention 1) detects that a door 22 is open 2) allows door 22 to remain open for a pre-determined period of time, 3) determines by various features that there are no obstructions in the doorway, 4) warns of door closure or soon-to-close status, 5) closes the door 22 after the programmed delay has expired, and 6) records and reports safety conditions detected.

In one aspect, display controller 40 is connected to an existing opener controller to over-ride or bypass the delay timer of the opener controller. Applicants have discovered that a typical delay timer of the opener controller comprises a potentiometer which limits the abilities of traditional opener controllers and systems. A potentiometer typically includes a dial which is physically adjusted by turning the dial to a set position. The potentiometer adjusts the time of delay for automatic closing of the door (i.e., the commercial door will automatically close upon lapse of the time-delay as set by the potentiometer, for instance). A delay timer using a potentiometer typically allows a user to set the delay between 5 and 300 seconds. Yet Applicants have recognized that the setting is not precise and is difficult to replicate. The potentiometer setting might be hand-adjusted to point to a 20 second interval, for instance, yet the actual delay time may be something very different than the desired 20 seconds. A user would have to make repeated timed tests and adjustment to the delay timer to achieve a desired delay interval. Also, setting the delay timer on one system 20 may produce a different time result as compared to setting the delay tier on a different system 20. Moreover, when the time lapses with such delay timer, a signal is immediately sent to the door controller 24b to immediately close the door without warning. Currently there is no signal generated by or from the delay timer or opener system to allow for a countdown of the remaining or lapsing time, and certainly no display available to broadcast or present the countdown to operators (such as truck drivers) of the impending or actual closing of the door. Heretofore, users or designers of such overhead door systems have not appreciated these deficiencies or have failed to recognize or realize benefits of bypassing such delay timer or utilizing a digital timer for automatic closing and accompanying warnings.

Moreover, commercial overhead doors are often damaged when a user strikes the door with their vehicle. A truck, for instance, may strike the door while attempting to exit or enter the doorway; not realizing the door is about to close or is closing. A person driving a vehicle may also attempt to avoid damage to the door by accelerating quickly through the opening, potentially causing additional safety concerns and also potentially damaging the door nonetheless. Heretofore, users or designers of such overhead door systems have not appreciated the use of camera technology to capture video of driving events where damage occurs to the door, especially as to capturing video clips of the area immediately prior to the damage (i.e., such as 10 seconds or one minute prior to the damage). Applicants have in further aspects of the invention created a system 30 and methods 100 for capturing video of such occurrences.

FIG. 1 depicts display system 30, which in one example is incorporated as part of overall opener system 20, which includes a commercial overhead door 22 having panels which hinge together and pivot during opening/closing operation. An operator/motor 24 is configured with a motor 24a and a door controller 24b, which operate to open and automatically close the door 22. Operator/motor 24 is located within interior of the door opening inside a building. In one instance a direct drive transmission from the operator 24 to a door shaft extends the width of the door 22, which rides on rails to open/close. Cable wires and drums, gears and/or other mechanical means are used to open and close the overhead door 22, which is powered by motor 24a. In one aspect system 20 undertakes opening/closing of the door 22 by use of radio transmitter activation; wireless control activation; or a push-button panel mounted to an interior wall of the building. Photo light beam units 28 (primary safety system) and edge sensors 26 (secondary safety system) are used to detect obstacles in the path of the doorway. The sensors 26 and units 28 are electrically connected to door controller 24b and cause door 22 to stop, reverse and reopen if an obstruction is detected. Cameras may also be used to confirm if an obstructions is detected. Opener system 20 and operator/motor 24 are configured to automatically close after a set period of time (i.e., after door 22 has been opened, a delay/timer is activated at door controller 24b so that door 22 automatically closes). A commercial overhead door opener system is one configured to have the door 22 automatically close after a lapse of time (unlike, for instance, a residential door opener system which closes upon push of a button by an operator and is not automatic). When the door 22 is fully open, a limit switch (representing a fully opened door) is activated within door controller 24. Once the time has lapsed (via potentiometer time delay setting n a traditional opener), the door 22 will automatically close. The limit switch is adjustable to set a point at which the motor stops moving the door (i.e., so the motor automatically stops at the set point, typically at the point or physical location where the door is fully closed).

Applicants have recognized, however, that problems arise where the door automatically closes. For instance, a door, which automatically closes with little or no warning, may result in damage to the door or to trucks or vehicles that enter the door space during the closing event. People may also be injured if they are contacted by the door upon closing. In some instances a person or driver approaching an open door will not appreciate that the door is about to close, or believes there is sufficient time to nonetheless pass through the opening before the door closes or is about to close. These situations result in damage to the door when the person drives a truck or other vehicle into the doorway and the door is closing or has recently closed; they also result in bodily harm to a person walking through an open door that suddenly begins closing. Systems 20, 30 and controller 40 and methods 100 are designed to reduce or eliminate damage to the door, vehicles and/or persons and provide other benefits as described.

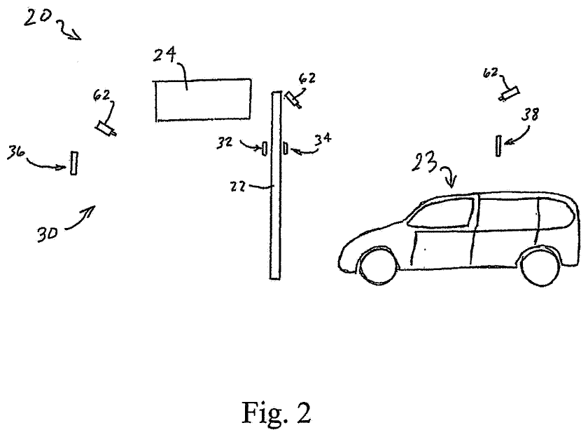

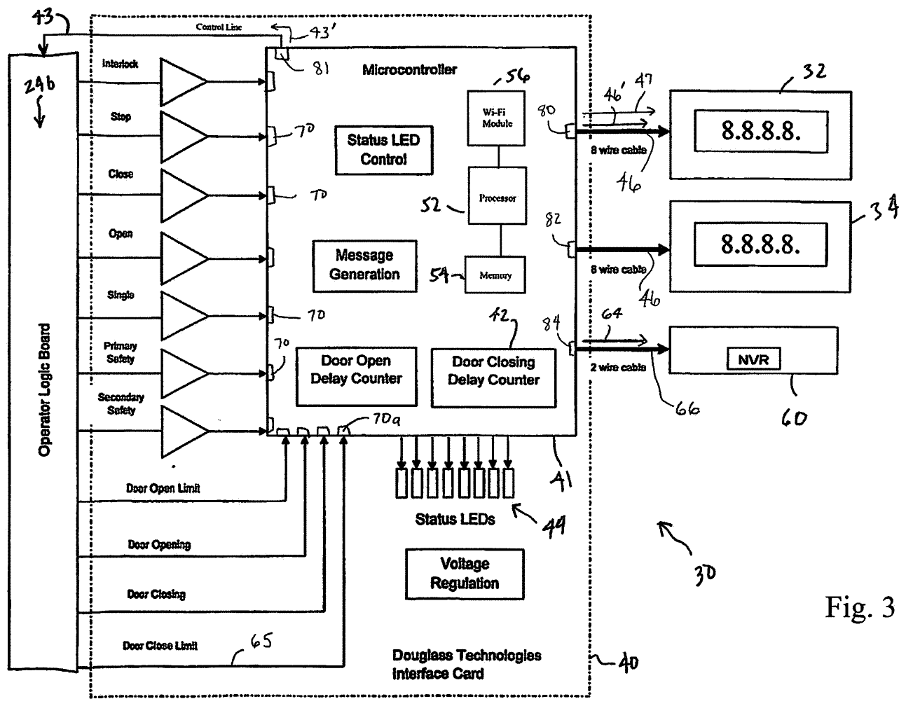

Opener system 20 is equipped with a display system 30 of the present invention. In one aspect, display system 30 includes a display interface card or controller 40 and at least one display unit 32. As shown in FIG. 1, FIG. 2 and FIG. 3, display system 30 includes a first display 32 and a second display 34. Additional units 32, 34 may be used on other configured doors (i.e., multiple doors 22 may be equipped with units 32, 34 so that system 30 can be used to control operation of the multiple doors). Units 32, 34 may be positioned internally and/or external the door 22 and building. Units 32 may also be positioned at various display locations within the building at a position removed from the door yet in viewing range of a driver of a truck or other vehicle or of a pedestrian, and units 34 may also be located outside the building at locations away from the door yet in viewing range to a person driving or a person walking into or out of the doorway. Units 32, 34 may be positioned on a wall or area next to the door 22 or doorway or projecting into the viewing area. Units 32, 34 may alternatively include LED bars or lamps or graphical images or other indicators not limited to multi-character digital displays. A multi-element digit, such as a 7-element or 12-element digit or multi-element LED matrix may be used for components of units 32, 34, for instance. Displays 32, 34 may also include multi-pixel displays configured to display a wide variety of images, graphics, words, numbers and the like, including scrolling information and/or video as desired.

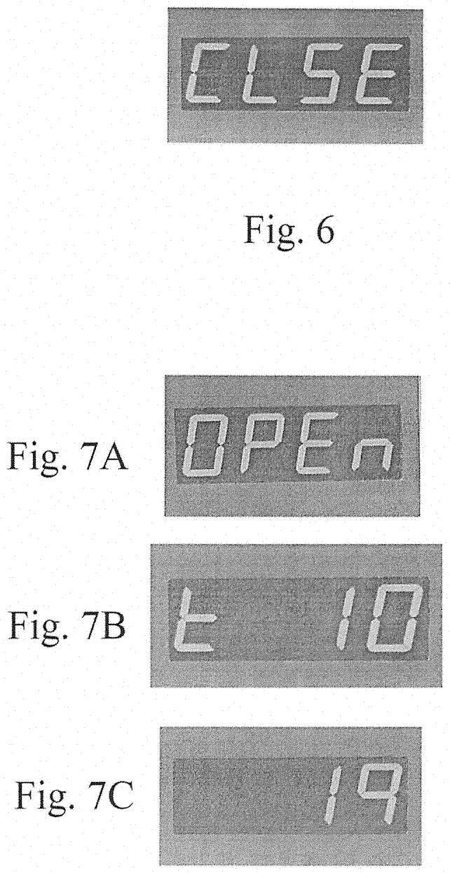

In one aspect display 32, 34 is a digital multi-character display unit. For instance, and with respect to FIG. 3, a display 32 is shown to have a four-character or four-digit display panel. In the present example, each of the characters or digits is represented by the numeral “8”, separated with periods “.”. Other characters (numerals, alphabet letters, or other symbols, may be used for the characters or digits. In further aspects with respect to FIG. 6 and FIG. 7 and FIG. 8, unit 32, 34 may depict a multi-character numerical or alpha or graphical display. In one aspect as shown in FIG. 6, display unit 32 depicts a CLSE message representing a “CLOSE” status of the door or a “closing” operation of the door 22. Other messages or warnings are provided as shown in the Figures. The display message CLSE is a displayed warning of the operation of systems 20, 30. The display is configured to flash at desired intervals and/or change colors for enhanced warning. Various and different colors of LED lights may comprise units 32, 34 and may form words, abbreviations, graphical images and messages. The display 32 is configured to display numerical digits and/or alpha-characters, letters and/or alphanumeric characters. In one aspect display 32 includes a four-digit display. Additional (or fewer) digits may also be used depending on the application. Additional digits may be used so that complete words, sentences or messages may be used as appropriate. The messages may change and scroll as desired and as programmed at controller 40. Display 32, 34 is configured to provide both numerical and alpha characters which allows for enhanced communication of a status of the systems 20, 30 and decreases or eliminates damage to the door 22.

FIG. 2 is a side view of opener system 20 having display system 30. In this aspect multiple displays 32, 34, 36, 38 are presented. Displays 36, 38 are positioned distal of door 22 so that an operator of a vehicle 23 may see such displays 36, 38 as they enter the doorway. Such displays 36, 38 are in addition to the displays 32, 34 that are positioned proximal door 22. Cameras 62 are also positioned to cover areas at the doorway entrance and/or exit, and multiple cameras 62 may be positioned to best capture activity at those areas.

System 30 includes display controller 40. In one aspect, controller 40 is positioned on a stand-alone circuit board and is configured to insert into a receiving port (or expansion port) of a pre-existing door controller 24b. In such aspect the pre-existing controller 24b is connected with a supplemental controller 40, for instance. In other aspects the components of controller 40 are integrated with the components, which comprise the circuit board of door controller 24b as a single unit. In further aspects controller 40 is retrofitted to electrically connect with the preexisting circuitry of door controller 24b.

With reference to FIG. 3, controller 40 in one aspect includes an adjustable door-closing delay counter 42. Counter 42 (and/or controller 40 with memory 54 containing software/instructions) is configured to be programmed with a set duration for a delay period. The controller 40 activates a numerical countdown display at display 32, 34, 36, 38, typically showing units in seconds. A display unit may be incorporated with controller 40 for display of such outputs. The units of seconds demonstrate the amount of time remaining until the door will automatically close or begins to close. Counter 42 may be adjusted by the user or installer at set-up or at subsequent times. Counter 42 in one aspect includes three single-digit counters, which may be manually adjusted to control the time delay. A button or buttons may be used to increase/decrease the displayed values for setting the time delay. Other counter devices or applications may also be used to provide adjustable time delay functionality. Controller 40 further includes status LEDs, a Status LED control module, a message generation module, and a Door Open Delay Counter. Status LEDs allow for warning messaging (similar to messaging at displays 32, 34) to be presented at controller 40 or for other status purposes to indicate the state of operation of controller 40. Table 1 shows non-limiting representative examples of the status LEDs:

TABLE 1
Status LEDs

| LED | COLOR | Function |
|---|---|---|
| 15 VDC | Green | Display power supply is on |
| 5 VDC | Green | Logic power supply is on |
| Timer Reset | Yellow | Flashes to indicate a counter reset event has |
| | | occurred |
| Timer to Close | Yellow | Flashes in sync with the countdown sequence |
| Fully Closed | Red | Indicates the door is currently in the fully |
| | | closed position |
| Door Opening | Green | Indicates the door is in motion in an upward |
| | | direction |
| Door Closing | Red | Indicates the door is in motion in a downward |
| | | direction |
| Fully Open | Green | Indicates the door is currently in the fully |
| | | open position |

In this example the 8 LEDs provided in Table 1 correspond to the 8 LEDs 44 shown in FIG. 3. The name or indicator of each LED may also be marked at the controller for reference.

In one aspect, a push button device connected to door controller 24b sends an operation signal or series of signals to controller 40 which signal is emulated by controller 40, such as at counter 42 or other component, to provide operation activity and output from controller 40. For example, OPEN, CLOSE and STOP signals are sent to the components and display units.

As further shown in FIG. 3, interface card or controller 40 is configured to receive input data from the door controller 24b (or derive necessary data via a connection with control board associated with operator/motor 24). Table 2 shows non-limiting representative signals received by controller 40 in one example.

TABLE 2
Signals derived from controller 40 or
received from the door controller 24b

| Signal | Origin | Definition |
|---|---|---|
| Interlock | Terminal Block | Maintenance Safety Lockout |
| Stop | Terminal Block | Stop Door Travel |
| Open | Terminal Block | Open Door |
| Close | Terminal Block | Close Door |
| Single | Terminal Block | Open Door |
| Primary Safety | Terminal Block | Photocell |
| Secondary Safety | Terminal Block | Resistive Door Edge |
| 24 VAC | Terminal Block | Auxiliary Power |
| 24 VDC | Connector | Main Power Source |
| Open Limit | Connector | Signals door id fully open |
| Door Opening | Connector | Signals door is moving up |
| Door Closing | Connector | Signals door is moving down |
| Closed Limit | Connector | Signals door is fully closed |
| Common | Connector | Board/Power Supply Ground |
| Remote Control | External Radio | Open Door |

In one aspect controller 40 includes a plurality of inputs 70 (or input terminals 70) to which electrical lines or cables from controller 24b are connected. Controller 40 communicates with door controller 24b by receiving a command signal or signals from the controller 24b, such as whether and when door controller 24 is to open and/or close, and also sends commands or signals to displays 32, 34, 36, 38 and to network video recorder NVR 60. In one aspect controller 40 includes a plurality of outputs 80, 81, 82, 84, (or output terminals 80) for instance, to which electrical lines or cables from controller 40 are connected. In other aspects controller 40 may also communicate with controller 24b via control line 43 (via output 81), for instance, to provide reverse or two-way communications and/or control. In one aspect, control line 43 is used to send a door closing signal from control 40 to controller 24b. The door close signal 43′ is used to bypass, for instance, a signal that is otherwise generated by controller 24b to close the door. A traditional controller 24b might utilize a potentiometer, for instance, to set and deliver a door close signal after a time delay interval. In one aspect of the present invention, however, such potentiometer or door close signal of the controller 24b is set to zero or disabled or turned off, and instead line 43 is connected to the inputs of control 24b to receive the signal 43′ from controller 40. This signal 43′ is sent at a precise time as set by delay counter 42 and as set or programmed within controller 40. Line 43 is connected directly to screw terminals of controller 24b in one aspect.

In one aspect display controller 40 includes a micro-controller 41 configured to receive the various inputs and to control the various outputs based on the programming logic. These inputs include, for instance, input from a push-button control box (such as a 3-button box with open, close and stop buttons, and other buttons such as light on/off or for other functions). These inputs also include inputs from safety sensors, such as inputs from the bottom edge detection strip 26 and/or photo beam unit 28. As shown in FIG. 3, examples of various inputs and sources include Open Door, Stop Door, Primary Safety (Photo-beam light), Secondary Safety (Resistive door Edge), Door fully Open, Door is moving in Open direction, Door is moving in Close direction, Door is fully Closed, Maintenance safety interlock, Main Power, Auxiliary Power and Ground. The circuitry within micro-controller 41 determines if and when the door controller 24b will close or open the door 22 through an internal analysis or processing of the external inputs (utilizing software and/or firmware 50 provided within micro-controller 41). For instance, data is received from controller 24b as inputs into controller 40, and the software program within controller 40 utilizes and responds to such data to undertake display operations using display units 32, 34, 36, 38 and also sends back to controller 24b a close door signal 43′ for instance. In this manner, display controller 40 controls the timing of the automatic closing of door 22, which allows controller 40 to also warn users of the status of the door 22 and when it is closing or about to close. In further aspects, several different controllers 24b associated with different doors 22 and doorways, may be connected to controller 40 or multiple controllers 40 in order to undertake control and display of the door closing operations for entire buildings or plants.

In operation door 22 is opened in the normal course and once fully opened, the close delay countdown commences, based on a countdown value (present for instance at counter 42 and programmed in software or firmware at controller 40), which has been previously set or programmed by the owner/operator of systems 20, 30. The time duration of the delay is determined by the owner/operator for the applications appropriate for the particular door and building location and purposes. When the timer reaches zero (or “00”), i.e., the set or predetermined delay period has run or lapsed (and the door has remained open), controller 40 sends a signal to display unit 32 (and/or other display units). In one aspect the signal sent to the display unit 32 upon lapse of the predetermined time is CLSE (See FIG. 6). The CLSE alpha-characters are formed by the LED display 32. In one aspect, the CLSE (which represents CLOSE or CLOSING) will display in a red color and may also flash. In one instance the CLSE warning will flash twice (and remain open for an additional 2 seconds, for instance) to provide a further warning of the impending door closure. During this period of delay and door closure, the safety sensors continue to monitor for safety conditions while the door is open and/or closing. If no safety faults are detected, upon the lapse of the set time and of the flash of CLSE, the door 22 will begin travel downward to close. If at any time during the closing motion any of the safety sensors produce a blocked or obstruction fault signal, controller 24b is programmed to automatically cause door 22 to stop its downward travel and return to fully open position and remains fully open until the safety fault is no longer present. Once all safety faults are resolved closing delay counter 42 is reset to its full programmed value, the process repeats (i.e., the delay counter 42 will count down and upon reaching zero will cause CLSE (or other indicator) to flash and then the door will again commence closing (unless a further safety fault or open command is experienced at controller 40).

With the door 22 in a fully closed position, a limit switch or door closed indicator within the door controller 24 will prevent the timer or delay counter 42 from activating. When the door 22 is fully opened, the limit switch will send a signal to controller 40 representing a fully open condition whereupon counter 42 will begin the counting delay operation described above. Alternatively, counter 42 will begin the counting delay operation when door 22 has reached a door fully open state (which in one instance is signified via a limit switch which will activate counter 42). In other aspects, the counter 42 may be activated upon the lack of presence of a door close limit signal (i.e., if such signal is not present, the timer may also commence counting). The time delay may be set and modified to range based on preference, and in one instance ranges between 3 seconds to five minutes, and in further aspects will be set to delay closing operation for 10 seconds and in other applications will be set to delay closing operation for 24 seconds or longer. The duration of the delay may be modified to fit the desired application. Historical data in one aspect of the time delays is reviewed so that management decisions may be made as to what time delay is optimal for operations. If the door 22 remains open even after the time delay has lapsed, a safety fault is noted and the door remains open. The door remains open until the safety condition is resolved and/or the door controller 24 is reset (either manually or via remote action).

While the door 22 is closing, a continuous warning, such as “CLSE” is displayed until the door 22 is fully closed. Once the door is closed, the display unit 32, 34 will no longer display a message or otherwise be blank. Again, during the period where the door is open, the video camera capture is activated. Such video data is useful for determining how and when damage might have occurred, and assist in preventing further or subsequent damage and identification of persons responsible for causing the damage or theft.

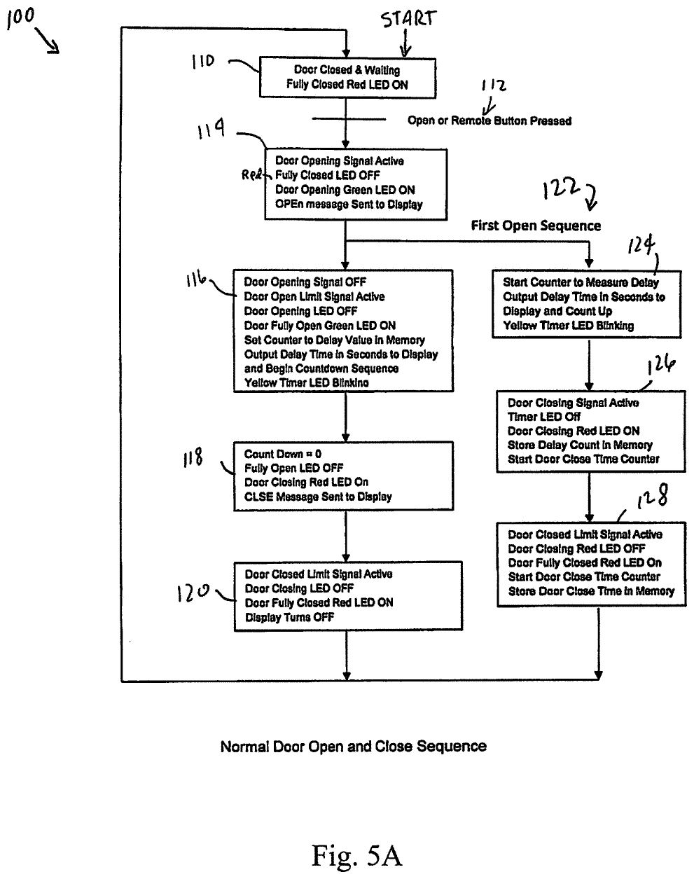

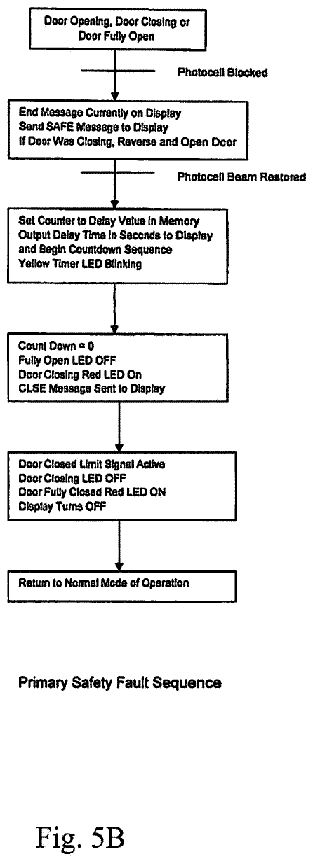

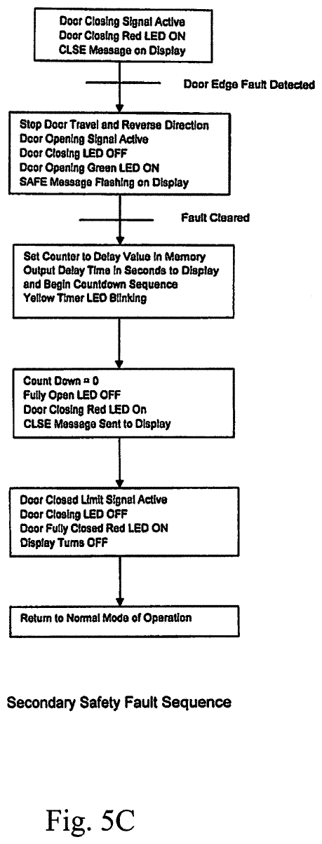

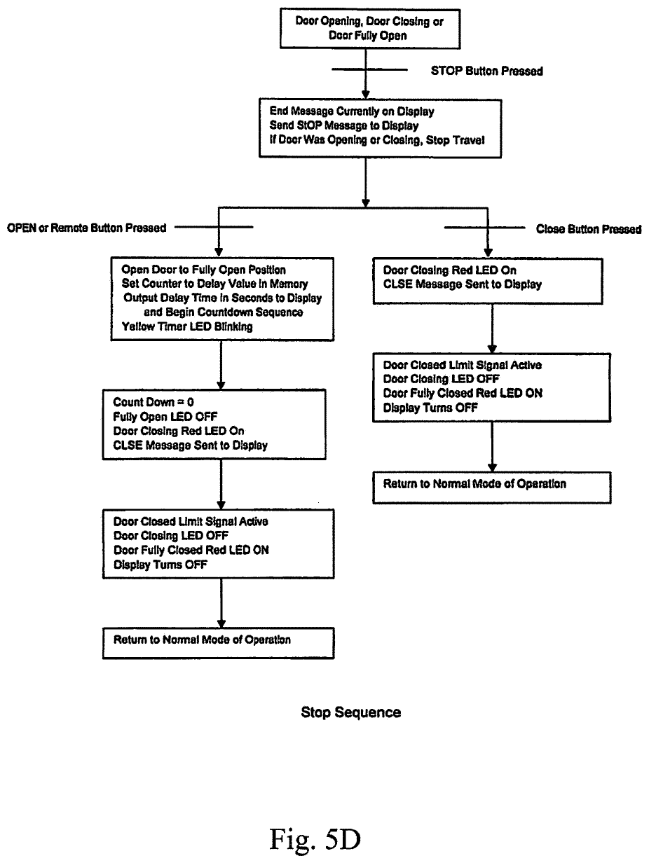

In further aspects and with reference to FIGS. 5A-5C depicting block diagrams, representative basic logic of system 20, 30 is shown. Various states of operation are presented. For instance, box 110 represents a START or initial step where door 22 is closed and waiting to be open and a display 32, 34 or a Red LED indicating a “closed” state is on or illuminated (i.e., CLSE) on controller 40. At step 112, a user or operator will press a button at a remote control or panel box to activate or “open” the door 22. Once the button or remote is pressed, a signal at controller 24b, 40 is received and at step 114 the Door Opening signal is activated. The Red Fully Closed LED is turned OFF at controller 40, display 32, 34 change from blank to display a flashing OPEn message and the Door Opening Green LED is turned on at controller 40. OPEn message will flash on display 32, 34 until the door is fully open. When the door reaches fully open position the Green Opening LED turns off and the Green Fully Open LED located on controller 40 turns on (i.e., the status LEDs 44 (FIG. 3) will illuminate or extinguish as appropriate. In such case, and with respect to the step at block 116, the counter 42 undertakes delay counter operation according to the set value and the Delay Calibration Time in Seconds is sent to display unit 32, 34 and Begin Countdown Sequence commences. The multi-character display 32, 34 will show the countdown in seconds. A Yellow Timer LED will blink at status LEDs 44. At block 118, count down reaches zero and the Fully Open LED 44 is turned off, Door Closing Red LED turned ON at controller 40 and a “closing” message is sent to display 32, 34, such as a CLSE message. When the door is closed, block 120, the Door Closed Limit Signal is active and Door Closing LED 44 is turned off at controller 40. The Door Fully Closed Red LED 44 is turned on at controller 40 and the display 32, 34 turns off by going blank, for instance. In the above operations, the display 32, 34 will flash the notices as appropriate and LEDs will flash as appropriate. In some instances, a CLSE warning will flash at one-second intervals.

In further reference to FIG. 5A, in instances where controller 40 uses door controller 24 timer, a First Open Sequence 122 or programming step is shown. For instance, at set-up where the system 20, 30 is installed and first operated and powered up by first opening the door 22, a Start Counter to Measure Delay is activated at block 124. When the push button or remote “open” button is pressed the display 32, 34 will show “OPEN” (with OPEN flashing in one second intervals, for instance). Once the door has reached the fully open position the Delay Calibration Time in seconds is sent to the display 32, 34 in seconds and counted upward (increasing numeric value), for instance t1, t2, t3 representing time 1 second, time 2 seconds, time 3 seconds, etc., until t24 (or some other time duration) is reached. The time duration is determined by adjusting a potentiometer at controller 24b. Once the fully open to fully close time is determined, the display will show CLSE. The person setting up the system will be able to verify the actual calibration delay time is with respect to the potentiometer setting to ascertain the actual time delay in seconds.

In further instances where controller 40 uses its time delay function, when the Door Closing Signal active is reached at block 126, the Timer LED 44 is turned off and the Door Closing Red LED is turned on at controller 40, and the time delay information or Store Delay Count, is stored in memory on controller 40, and Start Door Close Time Counter is activated. Also, when the count up reaches the pre-set time, the display 32, 34 will flash CLSE and the door 22 will begin to close. At block 128 the Door Closed Limit Signal is Active, the Door Closing Red Led 44 is turned off, the Door Fully Closed Red LED is turned on, the Start Door Close Time Counter is activated, and the Store Door Close Time in Memory is activated where the time delay is stored in memory on controller 40. Pushing the “open” button will then cause door 22 to open while OPEn is flashed on unit 32, 34 until the door stops in the open position. Once the door is stopped in the open position, the display will flash the countdown timer (in seconds) corresponding to the delay time stored in memory. Once the countdown timer and display reach zero or 0000, the door 22 begins to close and the display will flash CLSE. Optionally the zeros (or other indicator) will flash for a period of time (i.e., two or three seconds or two or three flashes, or other duration).

In one instance the countdown delay value is stored in flash memory. A countdown-reset button is provided on the controller 40, which allows the countdown value to be cleared. The reset function is achieved by pressing and holding the Counter Reset switch. The function LEDs, for instance, will sequence on from right to left and then sequence off in reverse order. While this is happening the displays 32, 34 will cycle through the segment test sequence. When the two green LEDs in the group begin to flash in unison, the memory location is cleared and the button can be released. The digital display will show the message ASEt (i.e. reset) for two seconds indicating the countdown timer value has been cleared and the display will then turn off. This function is useful during installation and setup to allow the delay potentiometer on the controller 24b and/or the digital timer on the controller 40 to be adjusted until the desired delay value is achieved.

In further aspects with respect to safety, controller 40 determines the unique time duration needed to move the door from fully open to fully closed during initial installation. This time duration is determined by the combination of the speed in which the opener motor (24a) moves the door and the size or height of the door being closed. In FIG. 5B, a primary safety fault sequence is shown in block diagram. In this sequence, when the beam of light from unit 28 is blocked, the messages and sequences as shown in FIG. 5B are implemented/activated. A similar sequence occurs in the case of a secondary safety fault sequent as shown in FIG. 5C, such as what may occur when edge sensors 26 detect an obstruction. FIG. 5D shows a block diagram for a stop sequence as presented. A variety of different functions and display messages may be incorporated into systems 20, 30, including such functions and displays as SAFE or ObSt (i.e., obstruction) or other or other message where a flashing SAFE or ObSt or other message appears until a malfunction is resolved during which time the door 22 is not allowed to close (but allowed to fully open). The SAFE indicator may be triggered, for instance, by operation of a secondary safety signal. The ILOC message appears for instance during periods of maintenance when a technician disables the ability to open and close the door while making repairs. The STOP message appears when a stop button is pressed when the door is not in a fully open or closed position. If the door was open with a countdown sequence in progress, the countdown sequence will terminate and the door will remain open until some action is taken to clear the STOP function. Pressing the open or close button can clear the Stop function and STOP warning. Pressing the remote control button, or removing an object interrupting the photocell beam will also remove the Stop function and warning. Pressing a reset button on controller 40 will establish or re-establish a set time delay, with the Yellow Timer LED 44 blinking or flashing.

Data sent from controller 40 to displays 32, 34 in one aspect travels via line 46, which in one instance is carried via an I²C Link. I²C is a standard two wire digital interface. The two I²C signals, along with various logic power, various display power and ground signals are all carried between the controller 40 and the displays 32, 34 by way of a single eight conductor Cat5 Ethernet cable in one example, such as via line 46. Modular connectors on the controller 40 and the displays provide easy installation for line 46. In one aspect, data such as a door closing signal 46′ is delivered via line 46. In one aspect, door closing signal 46′ and door closing signal 43′ are sent simultaneously or near-simultaneously to respective display units 46 and door controller 24b. Other data, represented by arrow or signal 47 (See FIG. 3) also travels to display 32 via line 46. Such other data or signal 47 may include, for instance, a numerical countdown, an alpha-character warning, or other signal or message to be displayed at a display 32, 34, 36, 38. The data or signals 46′, 47 may also be displayed simultaneously or nearly-simultaneously at multiple displays. In further aspects, a first display unit 34 and a second display unit 36 are both visible to a person entering or exiting through a doorway associated with the overhead door 22.

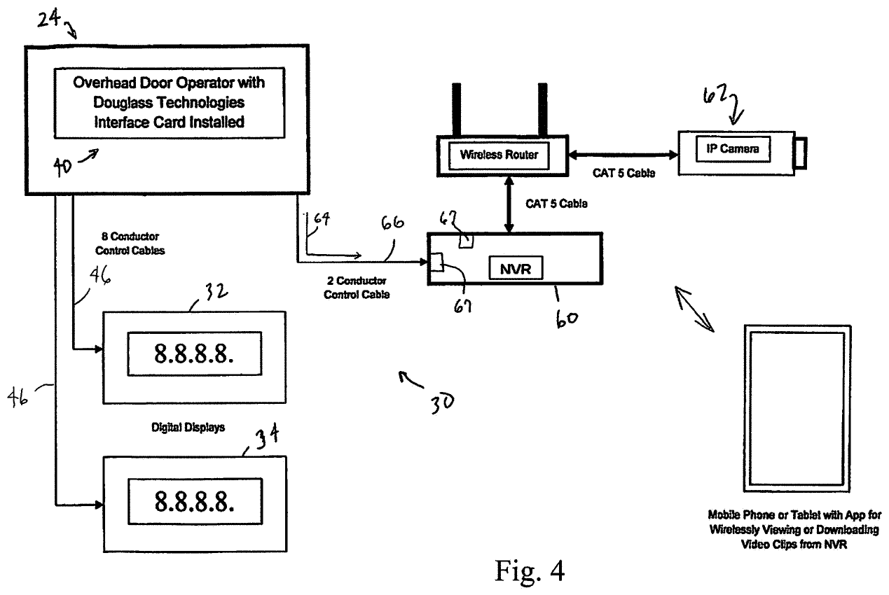

In further aspects with respect to FIG. 4, controller 40 provides an alarm signal 64 that can be used in conjunction with a video recorder such as a Network Video Recorder (NVR) 60 and a video camera such as an HD IP video camera 62 to capture video any time the overhead door 22 is open (or for a desired interval of time before and/or after opening). As noted herein the controller 40 and video recorder are also configured to capture image where there is contact made to the door. The alarm signal 64 travels via control cable 66, such as two wires or a two conductor cable. In other aspects alarm signal 64 is a wireless signal transmitted from controller 24b to a recorder 60.

In one aspect as shown in FIG. 4, controller 40 is connected or integrated within controller 24b. For instance, interface card 40 may insert into a designated input or slots configured within controller 24b. In other aspects, however, controller 40 is positioned outside of controller 24b or otherwise connected to controller 24b via wires or cables. A series of connecting lines run from various outputs and inputs of controller 24b to the various inputs 70 and outputs 80 of display controller 40.

In further aspects, sensors or motion detectors, including, for instance, accelerometers, may also be used to initiate recordation. For instance, a sensor 90 may include an accelerometer connected to door 22. When door 22 is struck such that accelerometer exceeds a pre-set limit, a signal, such as a wired or wireless signal, is sent to controller 40 (via Wi-Fi 56 for instance) and or directly to recorder 60 to activate video file creation. In one aspect, the sensor 90 sends a signal to controller, which in turn sends alarm signal 64 to recorder 60 to record or store the event (including storing video recorded prior to the event as noted herein). Additional sensors such as compression sensors 92 (pressure inducers for instance) are provided on door 22 or around a doorframe or rail or building adjacent door 22 to receive impact warnings (and to send a signal in the event of a crash or striking of the door or structures adjacent the door 22). These and other sensors 92 may also provide a wired or wireless signal to controller 40 to trigger alarm signal 64 for recording the event. Typically this system would be used to monitor the door opening to ensure intruders do not enter the building while the door is open, or to capture video of an event such as a vehicle running into a door that is closing.

In one aspect, an alarm signal 64 is generated by monitoring a DOOR CLOSED LIMIT signal 65 (See FIG. 3) from the controller 24b. In one aspect, signal 65 is connected to an input 70a by an electrical line or cable running from controller 24b. Any time this DOOR CLOSED LIMIT signal 65 is not present it indicates the door 22 is in motion; is fully open; or stopped somewhere between the open and closed limits. The absence of this signal 65 causes the alarm output on the controller 40 to activate, by sending alarm signal 64, for instance. Connecting this output (i.e., sending alarm signal 64) to an alarm input 67 on a recorder such as an NVR 60, for instance, and setting the NVR device to record (or to create a video file for storing or archiving) upon receiving the alarm input (i.e., when it receives alarm signal 64) allows the NVR to record video for the duration of time that a door 22 is not fully closed. Once the DOOR CLOSED LIMIT signal 65 is again detected, the alarm output (i.e., alarm signal 64) is disabled, signaling to the NVR to stop recording. Software programming may be configured to select desired delay times for starting or ending the recordings. In other aspects, the NVR is continually recording by use of cameras 60. When the alarm signal 64 is received by NVR 60, NVR will create a stored video file of the recorded video). This file is time-stamped and archived and/or sent to an administrator or user. The file may be sent via email or text message or otherwise sent or delivered for further review. In some instances the NVR 60 will continuously record video for long periods of time, and will automatically over-write such recorded video with current video. The NVR may be set to record 24 hours of continuous video, for instance, or a seven-day continuous period of video. Other lengths of video recording may be used as desired. In one aspect, and instead of over-writing and replacing the recorded video, a video file is created upon sending of alarm signal 64 and preserved. Moreover, in one aspect controller 40 and NVR 60 is configured so that the video file, which is stored, includes video recorded or captured prior to the NVR receiving the alarm signal 64. This allows for the video file to show events transpiring prior to the alarm signal 64. For instance, the video file may be set to store video of events occurring 1 minute prior to receiving the alarm signal 64 so that actions taking place prior to the alarm may be captured. Yet further, the alarm signal 64 may be sent to the recorder 60 in response to an action of or to the door 22 such as a striking of the door by a vehicle. For instance, sensors 90, 92 are positioned at door 22 or at locations adjacent door 22, where the sensors are configured to send signals to controller 40 upon occurrence of an event (such as a strike of the door). For instance, if a truck were to strike door 22 such that an accelerometer 90 or pressure sensor 92 activates to send a signal to controller 40 (via wireless communication for instance), controller processes the received signal and delivers an alarm signal 64 to recorder 60.

In an alternatives, operation of the delay counter 42 is initiated upon Door Open Limit signal (FIG. 3) being present from the door opener controller 24b (i.e., the door open limit signal is present, which means the door is open, which starts the delay counter) (or could start the delay counter; the delay counter in one aspect is typically started upon the door being fully opened). In alternatives, operation of the delay counter may be initiated upon discontinuation of a door status signal from the door opener controller 24b (i.e., programmed such that if the door close limit signal is no longer present at controller 40, which means the door is open, the delay counter starts.

Using an NVR 60 that has multiple alarm inputs 67 allows a single video recording unit to be used to monitor multiple overhead doors. This is accomplished by connecting the alarm output 66 from multiple operators equipped with controllers 40 to one of the several individual alarm inputs 67 on the NVR. The number of doors 22 that can be monitored is limited by the number of alarm inputs 67 provided on the NVR itself (or additional NVR software and associated massive storage units may be added to the system 20).

In one aspect and with reference to FIG. 3, controller 40 or processor module includes a processor 52 which receives information from various devices such as sensors 26, 28 or other sensors, antenna, Wi-Fi unit 56, or other components, and compares the information to one or more thresholds or data stored in memory 54, such as one or more signal frequencies, codes, or other data or other thresholds. Based on the comparison, controller 40 utilizes instructions such as software instructions or activates other systems or controls other steps. Controller 40 may also adjust systems 20, 30 based on user input setting target thresholds or data or overriding of desired aspects of controlled systems or objects. Controller 40 may be informed of target thresholds or comparison data by receiving user input via a user interface device and storing the input in memory 54. Signal data or other data or thresholds is stored in memory 54 by sending signals and information wirelessly (or via hard wire) to controller 40. A Wi-Fi unit 56 receives wireless control data and passes the data/signal to controller 40. Wi-Fi unit 56 may be associated directly with controller 40 or may comprise a separate component. Wi-Fi unit 56 in one aspect comprises a Bluetooth, near field communication (NFC) or other variety of communication or component for use in sending and receiving wireless signals. For instance, unit 56 and/or controller 40 or other chip or board may be configured to send and receive Bluetooth wireless data for operation and information distribution.

The monitoring, analysis, and data gathering techniques of the disclosure can be implemented in hardware, software, firmware or any combination thereof. In one aspect, system 20, 30 includes a controller 40 which includes a computer chip or circuitry configured to control the electrical operation of system 20, 30 including stored application software programs. In other examples, various aspects of the techniques may be implemented within one or more processors, including one or more microprocessors, DSPs, ASICs, FPGAs, or any other equivalent integrated or discrete logic circuitry, as well as any combinations of such components. Such hardware, software, firmware may be implemented within the same device or within separate devices to support the various operations and functions described in this disclosure. When implemented in software, the functionality ascribed to the systems, devices and techniques described in this disclosure may be embodied as instructions on one or more non-transitory computer-readable medium such as RAM, ROM, NVRAM, EEPROM, FLASH memory, magnetic data storage media, optical data storage media, or the like. The instructions may be executed to support one or more aspects of the functionality described in this disclosure.

In further aspect a method 100 includes displaying a numerical countdown and a door-closing warning at a first display unit 32, the warning occurring while a commercial overhead door 22 is closing or about to close and after display of the numerical countdown. In further aspects the method includes retro-fitting conventional commercial door opener systems having legacy controllers 42b utilizing a potentiometer as an automatic delay counter, and bypassing or disabling the legacy delay counter, receiving input data from the legacy controller 42b, and outputting a door close signal 43′ to the legacy controller 42b and outputting a door close signal 46′ to a display unit 32 or units, including display of a numeric countdown and an alpha warning. In one aspect the legacy counter is disabled or bypassed, with a wire connection passing from controller 40 at output 81 to an input at controller 24b. Controller 40 includes inputs 70 which receive wire connections from controller 24b so that controller 40 receives all normal indicators and data from a legacy system.

In further aspects the invention includes methods of recording events occurring at an overhead door opener system 20 configured to automatically close based on a time lapse, the method including continually recording a video stream from a camera 62 directed at an entrance or exit of the overhead door 22, and creating a video file of at least a portion of the recorded video stream upon receipt of an alarm signal sent in response to action of the door 22, the video file having a time-stamp corresponding to the alarm signal 64, the video file including video recorded prior to receipt of the alarm signal 64. In aspects, the time-stamp and recorded video clip is of a time prior to receipt of the alarm signal 64, the video file continuing to the end of the event. The video file is archived and may be sent to email or text or other communication accounts.

It should be understood, of course, that the foregoing relates to exemplary embodiments of the invention and that modifications may be made without departing from the spirit and scope of the invention as set forth in the following claims.

What is claimed is:

1. A display system for use with an overhead door opener system having a door opener controller configured to open and automatically close an overhead door, the display system comprising:
a first multi-character display unit; and
a display controller having an adjustable door-closing delay counter, the display controller configured to utilize the delay counter to activate a numerical countdown and an alpha-character door-closing warning at the first display unit, the controller configured to send the door-closing warning via a door closing signal to the first display unit while the overhead door is closing and after display of the numerical countdown at the first display unit.

2. The display system of claim 1 further comprising a second multi-character display unit, the controller configured to send the door-closing warning for simultaneous display at the first display unit and at the second display unit.

3. The display system of claim 1 where the display controller is operatively connected to the door opener controller of the overhead door opener system.

4. The display system of claim 1 where the display controller is configured for electrical connection to the door opener controller of the overhead door opener system so that a door close signal from the display controller sent to the door opener controller activates a closing of the overhead door.

5. The display system of claim 4 where the display controller is configured to send the door close signal upon completed countdown of the door-closing delay counter.

6. The display system of claim 5 where the display unit displays a numerical countdown and upon the door-closing delay counter reaching zero displays the alpha-character door-closing warning.

7. The display system of claim 1 where the display controller is electrically connected to the door opener controller and receives signal data from the door opener controller of the overhead door opener system and is configured to send a door close signal to the door opener controller upon completed countdown of the door-closing delay counter.

8. The display system of claim 1 where the display unit includes a digital display having at least two alphanumerical digits.

9. The display system of claim 1 where the display unit includes a display configured for displaying letters forming complete words.

10. The display system of claim 1 further comprising a camera configured to capture image data adjacent the door while the door is opening, closing, waiting to open, or waiting to close.

11. The display system of claim 1 where the display controller is configured to send an alarm signal upon action of the door, the system further comprising a video recorder configured to continually record a video stream from a camera directed at an entrance or exit of the door, the system further configured to create a video file of at least a portion of the recorded video stream upon receipt of the alarm signal.

12. The display system of claim 11 where the video recorder is configured to receive the alarm signal and where the video file includes video recorded at the video recorder prior to receipt of the alarm signal.

13. The display system of claim 11 where the display controller includes an input configured to receive a door strike signal representing one action of the door and initiating sending of the alarm signal, the door strike signal initiated by activation of a switch or sensor at or adjacent the door.

14. The display system of claim 1 where the display controller includes a memory coupled to a processor, and instructions stored on the memory which, when executed, perform a method, comprising:
receiving a door status signal from the door opener controller;
initiating, based on the door status signal, operation of the delay counter having a pre-set time interval;
sending a countdown signal to the display unit; and
sending, upon lapse of the pre-set time interval, a first door-closing signal to the door opener controller and a second door-closing signal to the display unit.

15. A display system for use with an overhead door opener system having a motor and a transmission configured to open and automatically close an overhead door, the display system comprising:
a first display unit;
a display controller having an adjustable door-closing delay counter, the display controller configured to activate a numerical countdown and a door-closing warning at the first display unit, the controller configured to display the door-closing warning at the first display unit while the overhead door is closing and after display of the numerical countdown at the first display unit, the display controller further configured to send an alarm signal upon motion of the door; and
a video recorder configured to create a video file upon receiving the alarm signal.

16. The display system of claim 15 where the video recorder is a network video recorder (NVR) configured to continually record a video stream from a camera, the video file comprising at least a portion of the recorded video stream and designated with a time-stamp and archived.

17. The display system of claim 16 where the time-stamp corresponds to a time of receiving the alarm signal.

18. The display system of claim 17 where the video file includes video recorded prior to receipt of the alarm signal.

19. A method of recording events occurring at an overhead door opener system configured to automatically close based on a time lapse, the method comprising:
continually recording a video stream from a camera directed at an entrance or exit of the overhead door; and
creating a video file of at least a portion of the recorded video stream upon receipt of an alarm signal sent in response to action of the door, the video file having a time-stamp corresponding to the alarm signal, the video file including video recorded prior to receipt of the alarm signal.

20. The method of claim 19 where action of the door includes a contacting of the door.

21. The method of claim 19 where the action of the door includes one from the group of the door opening, the door closing, and activation of a sensor of the door.

22. The method of claim 19 further comprising displaying a countdown time and an alpha status at a display positioned adjacent the door.

23. A door opener display controller for use with a door opener controller configured to activate an automatic door closing of a door, the display controller comprising:
an interface card having a digital door closing delay counter and a plurality of inputs and a plurality of outputs;
at least one of the inputs configured to receive a door status signal from the door opener controller which initiates operation of the delay counter, the delay counter configured to count a pre-set time interval to cause the display controller to send a count-down signal from a first output configured for communicating the count-down signal to a display, and upon lapse of the pre-set time interval to cause the display controller to send a first door closing signal from a second output configured for communicating the first door closing signal to the door opener controller to begin closing the door and to send a second door closing signal from the first output configured for communicating the second door closing signal to the display.

24. The door opener display controller of claim 23 where the overhead door opener has a potentiometer configured to activate the automatic door closing of the door, the second output configured for bypassing the potentiometer.

25. The door opener display controller of claim 23 where the door status signal received at the at least one of the inputs includes one from the group of a door open limit signal, a door opening signal, a door closing signal and a door close limit signal.

26. A commercial overhead door opener system having a door and a display unit and a display controller in accordance with the display controller of claim 23.
